(19) United States
(12) Patent Application Publication
(10) Pub. No.: US 2003/0038815 A1
(43) Pub. Date: Feb. 27, 2003

(54) Display device capable of dynamically compensating effect of environmental light

(76) Inventor: Wen-Sung Tsai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,729

(22) Filed: Feb. 7, 2002

(30) Foreign Application Priority Data
Aug. 23, 2001 (TW) 090120709

(51) Int. Cl. G09G 5/02

(52) U.S. Cl. 345/589

(57) ABSTRACT

A display device is provided for a computer system. The display device includes a screen for displaying a color picture image formed by at least two light sources, at least one sensor for detecting light around the screen and generating a corresponding detecting signal, a gray level adjusting device for adjusting brightness of light emitted by the light sources according to the detecting signal so as to reduce an impact of light around the screen to the color picture image on the screen, and a controller for controlling operations of the display device.

### BACKGROUND OF THE INVENTION

1. Field of the Invention

The present invention relates to a display device for a computer system. More specifically, the present invention discloses a display device capable of detecting a color of light around the display device so as to reduce an impact of light around the display device on the displayed color of the display device.

2. Description of the Prior Art

In modern society, a computer system with a capability for dealing with digital signals is one of the major prerequisites for arranging, storing, and exchanging amount of data and information.

Colors can easily show important information such as with traffic signals or traffic symbols. Artists use colors to express human emotions and feelings. Since colors can transmit both data and sense information, it is a major goal for information technology to supply color information without errors for users through computer or information products.

The information products such as computer systems display picture images through display devices. For example, a computer utilizes a CRT display device to display a picture image whereas a portable computer device utilizes a liquid crystal display (LCD) device to display the picture image. The display devices will perform a color adjusting procedure to adjust colors outputted by the display device. This color adjusting procedure is done under the assumption that the background environment of the computer device is completely dark.

Although the display device performs the color adjusting procedure under the assumption that the background of the computer environment is completely dark, actually, a user must operate the display device under an environment with a certain light source. The light source causes the colors displayed on the display device to be affected by the environmental background. For example, if a color of the environmental background light is blue, the color displayed on the display device will be blue. The aforementioned problem is called a color-rendering problem in optics. A deviation of colors displayed on the display device due to the colors of the background of the display device cannot be compensated by using the prior art color adjusting procedure. The prior art display device has this limitation because manufacturers do not presuppose that the display device will be used under different backgrounds.

### SUMMARY OF INVENTION

It is therefore a primary objective of the claimed invention to provide a display device with a sensor to dynamically adjust color displayed by the display device according to a color of light around the display device so as to prevent picture images displayed by the display device from being affected by the light around the display device.

The claimed invention discloses a display device for a computer system. The display device has a screen for displaying a color picture image formed by light from at least two light sources, at least one sensor for detecting light around the screen and generating a corresponding detecting signal, a gray level adjusting device for adjusting brightness of light emitted by the light sources according to the detecting signal so as to reduce an impact of light around the screen to the color picture image on the screen, and a controller for controlling operations of the display device.

It is an advantage of the claimed invention that the display device utilizes a sensor to detect light around the display device and correspondingly adjust the color of the display device displayed through the screen so as to compensate color errors caused by the light.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1A is a perspective view of a computer system according to the present invention.

FIG. 1B is a magnified diagram of a sensor depicted in FIG. 1A.

FIG. 2 is a functional block diagram of a display device connected to the computer system according to the present invention.

FIG. 3A, FIG. 3B, and FIG. 3C are diagrams of indicating values of display signals compared to intensity of the corresponding light source according to the present invention.

FIG. 4 is a perspective view of a display device of a portable computer system according to the present invention.

FIG. 5 is a perspective view of another display device according to the present invention.

### Detailed Description

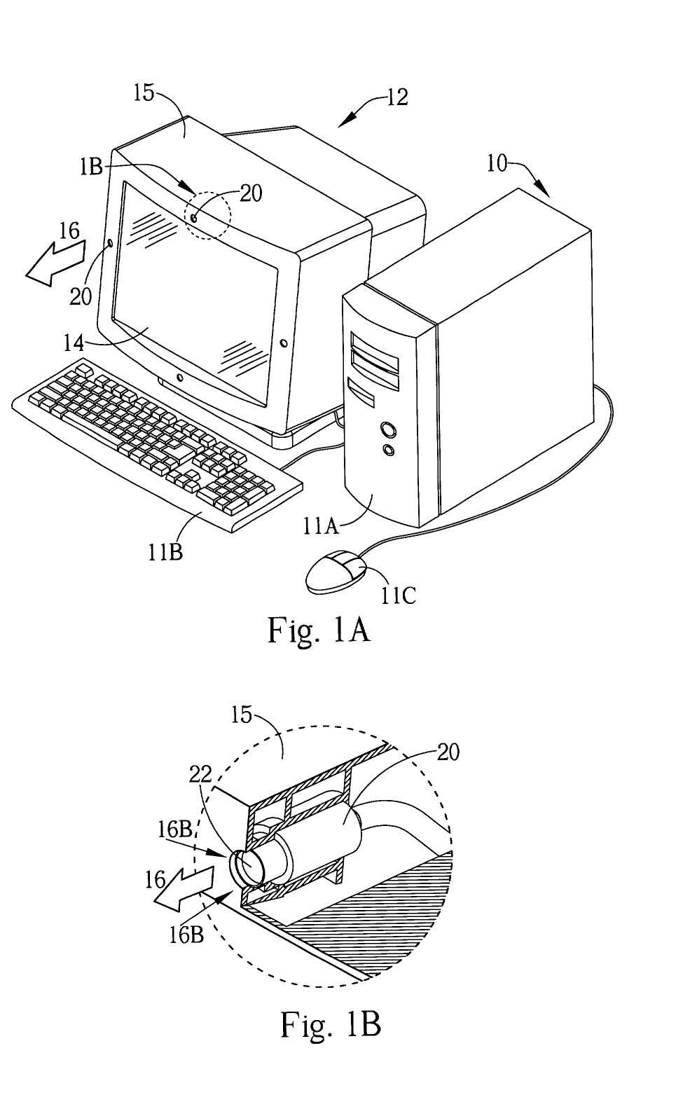

Please refer to FIG. 1A. FIG. 1A is a perspective view of a computer system 10 according to the present invention. The computer system 10 comprises a host 11A for controlling operations of the computer system 10, a keyboard device 11B for inputting orders and controlling the computer system 10 for a user, and a mouse 11C. The computer system 10 further comprises a display device 12 for displaying data of the computer system 10. A casing 15 covers the display device 12, and the casing 15 comprises a screen 14 for displaying a color picture image for a user in front of the screen. Obviously, the present invention can also be applied in a simple computer system such as an information apparatus. For detecting light around the display device 12, the first embodiment of this invention comprises four sensors 20 around the screen 14 on the casing 15.

Please refer to FIG. 1B. FIG. 1B is a magnified diagram of the sensor 20 depicted in FIG. 1A. Structures of the four sensors of this invention are the same, so the sensor 20 on the top of the screen 14 (the sensor indicated with a dotted circle 1B depicted in FIG. 1A) will be used as an example. The sensor 20 comprises a sensing surface 22 facing forwards in a direction of an arrowhead 16 for receiving light incident on the screen 14. Therefore, light incident on the sensing surface 22 of the sensor 20 in a direction of 16B will be detected by the sensor 20. The sensor 20 can be an image sensor formed by a charge-coupled device or a complementary metal-oxide-semiconductor (CMOS) sensor for detecting and receiving color images, and generating a corresponding detecting signal.

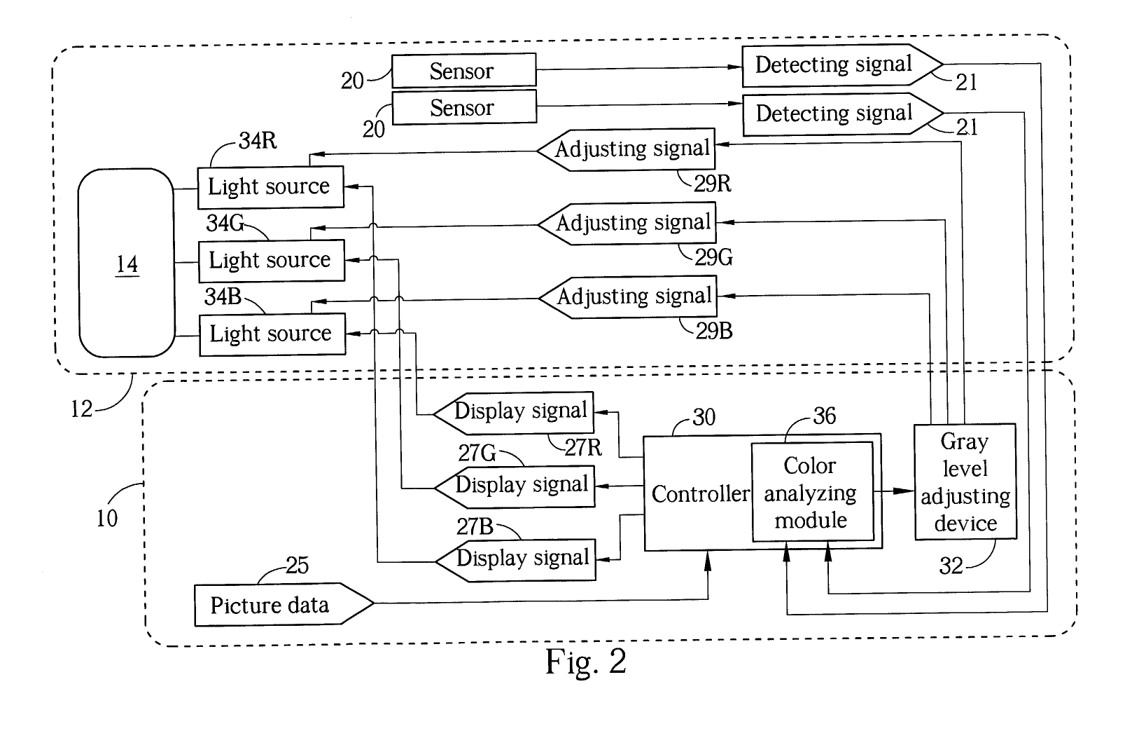

Please refer to FIG. 2. FIG. 2 is a functional block diagram of the display device 12 connected with the computer system 10. The display device 12 comprises a plurality of sensors 20 (FIG. 2 shows two) for detecting light incident on the sensing surfaces of the sensors 20 and generating the corresponding detecting signals 21. The display device 12 further comprises a plurality of light sources 34R, 34G, and 34B (FIG. 2 shows three) capable of emitting light of red, green, and blue colors respectively. The spirit of this invention can also be used in a light source system with light of different colors. In the display device 12, light of different colors, brightness, or or intensity emitted from the light sources of different colors intermixes so as to display a color picture image on the screen 14. For example, blue light of low intensity intermixed with red and green light of high intensity will display yellow color on the screen 14. Likewise, green light of low intensity intermixed with red and blue light of high intensity will display purple color on the screen 14. The light sources of a cathode-ray tube display device are electronic guns capable of exciting different colors on the screen. The light sources of a liquid crystal display (LCD) device can control display pixels to form different colors so as to display different colors by the LCD device.

The computer system 10 comprises a controller 30 having a color analyzing module 36 installed within the controller 30, and also comprises a gray level adjusting device 32. When a color picture image is displayed on the screen 14 of the display device 12, the computer system 10 transmits picture data 25 of the picture image to the controller 30. Then, the controller 30 will analyze the intensity of different color light in the picture data 25 and output corresponding display signals 27R, 27G, and 27B, respectively, according to the light sources 34R, 34G, and 34B. After receiving the corresponding display signals 27R, 27G, and 27B, the light sources 34R, 34G, and 34B will respectively emit light of the corresponding colors with different intensities so as to display the color picture image on the screen 14.

As described above, color displayed on the screen 14 will be altered by light around the screen 14. For adjusting color alterations caused by light around the screen 14, the present invention utilizes the sensor 20 to detect light around the screen 14 and generate the detecting signal 21. After transmitting the detecting signals 21 of the sensors 20 to the controller 30, the color analyzing module 36 analyzes the detecting signals 21 so as to differentiate brightness of light around the screen 14 corresponding to light generated by the different light sources 34R, 34G, and 34B. For example, if the color of light around the screen 14 is yellow, the color analyzing module 36 will determine that light around the screen 14 is formed by the blue and green light of high intensity, and transmits analyzing results to the gray level adjusting device 32. Therefore, the gray level adjusting device 32 respectively emits adjusting signals 29R, 29G, and 29B to the corresponding light sources 34R, 34G, and 34B according to composition of light around the screen 14. After receiving the corresponding adjusting signals 29R, 29G, and 29B, the light sources 34R, 34G, and 34B adjust intensity of outputted light so as to adjust the color of light displayed on the screen 14. As another example, if the color of light around the screen 14 is yellow, light around the screen 14 has green and red light with great intensity. Therefore, the gray level adjusting device 32 utilizes the adjusting signals 29R, 29G to control the light sources 34R, 34G to reduce the intensity of the outputted light so as to display a color picture image with a true color on the screen 14.

The present invention can utilize different structures to perform the above-mentioned color compensation. In general, a display device of a computer system is controlled by a graphics card or a video card. The controller 30 shown in FIG. 2 is the graphics card of the computer system, and the color analyzing module 36 can be an arithmetic wafer installed within the graphics card for dealing with the detecting signals 21 of the sensors 20. The gray level adjusting device 32 can be realized by an electric circuit function of the graphics card. Another preferred method is that the controller 30 and the color analyzing module 36 are formed by the electric circuit of the graphics card, and the gray level adjusting device 32 function is performed by a software program of the computer system 10. Under this structure, the color analyzing module 36 of the graphics card transmits the result of analyzing light around the screen 14 to an operating system of the computer system 10, the operating system performs the software program to complete the function of the gray level adjusting device 32, and then the gray level adjusting device 32 outputs the adjusting signals through the operating system. The other preferred method is that the controller 30 is the graphics card, and the color analyzing module 36 is another hardware circuit. The operating system of the computer system can perform a corresponding driving program of the color analyzing module so as to get an analyzing result of the color analyzing module. The operating system of the computer system can also perform the gray level adjusting device function of the software program according to the analyzing result in order to change colors outputted from the display device through the driving program of the graphics card so as to adjust colors. The above-mentioned preferred embodiments of this present invention utilize the sensors to continually detect changes of light around the screen so as to dynamically compensate the impact of environmental light.

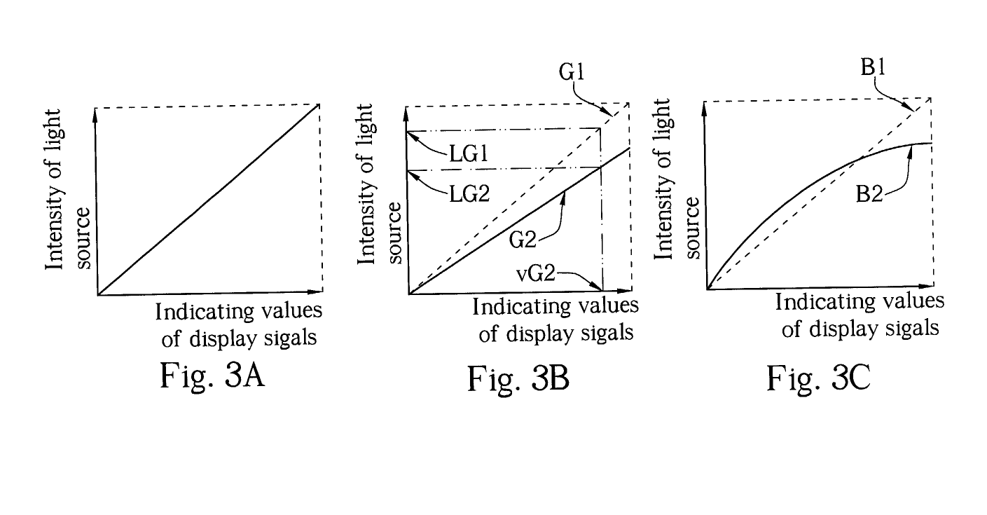

Please refer to FIGS. 3A to FIG. 3c. FIG. 3A, FIG. 3B, and FIG. 3C are diagrams of indicating values of display signals compared to intensity of the corresponding light source according to the present invention. As explained above, each light source in the display device 12 will be controlled by a corresponding display signal to determine intensity of outputted light. For example, when an indicating value of the display signal is zero, the corresponding light source outputs light with a lowest intensity, and when the indicating value of the display signal is greater than a certain value, the light source outputs light with a corresponding greater intensity. Furthermore, the light sources respectively receive corresponding adjusting signals so as to adjust intensity of the outputted light according to the corresponding adjusting signals. If light around the screen 14 is yellow, obviously, light around the screen 14 has green and red light with greater intensity. Therefore, red and green light generated by the display device must be reduced, and intensity of blue light remains unchanged. At this very moment, a functional relationship between the display signals of the blue light source and intensity of the corresponding light source can be maintained as shown in FIG. 3A. If the picture data 25 wish to display a pure blue color, the indicating value of the display signal of the corresponding blue light will be higher. This means the blue light source will be in accordance with the higher indicating value to output blue light with high intensity, according to a linear relationship shown in FIG. 3A, so as to display the pure blue color on the screen 14. Additionally, light around the screen 14 is yellow, so the outputs of the red and green light sources of the display device will be relatively reduced. Under control of the corresponding adjusting signals, the functional relationship between the display signals of the green and red light sources and intensity of the light sources can be shown as FIG. 3B and FIG. 3C, respectively.

As shown in FIG. 3B, the functional relationship between the display signals and outputted intensity of the light sources has changed to a functional relationship G2 under adjustments of the corresponding adjusting signals. A functional relationship G1 formed by a dotted line shown in FIG. 3B is a functional relationship of the display signals before adjusting. The functional relationships G1, G2 have the same indicating value vG2 of the display signals both before and after adjusting signals. The functional relationship G2 is corresponding to a lower intensity LG2 of the light source and different from a higher intensity LG1 of the light source which the function relationship G1 corresponds to. Because light around the screen 14 has green light with a higher intensity, the adjusting signals correct the functional relationship G1 to the functional relationship C2, and the functional relationship G2 will output the indicating values of the display signals with a lower outputted intensity so as to adjust the colors displayed on the screen 14 for the user. As shown in FIG. 3C according to the same principles, the functional relationship of the red light source between the display signals and intensity of the light source is also corrected from a functional relationship B1 (a dotted line) to a functional relationship B2 according to the corresponding adjusting signals. After adjustment, the functional relationship B2 will reduce the outputted intensity of the red light source. In this preferred embodiment, the functional relationship B2 is a curve so as to reduce the intensity of the outputted light and perform gamma correction of light. A module correcting the functional relationship of the display signals can be computed by the gray level adjusting device 32. The gray level adjusting device 32 electrically connected to a database of the computer system 10 can search a predetermined adjusting signal in the data base according to the analyzing result of the color analyzing module 36 so as to correspondingly correct the functional relationships to generate an expected picture image for the user.

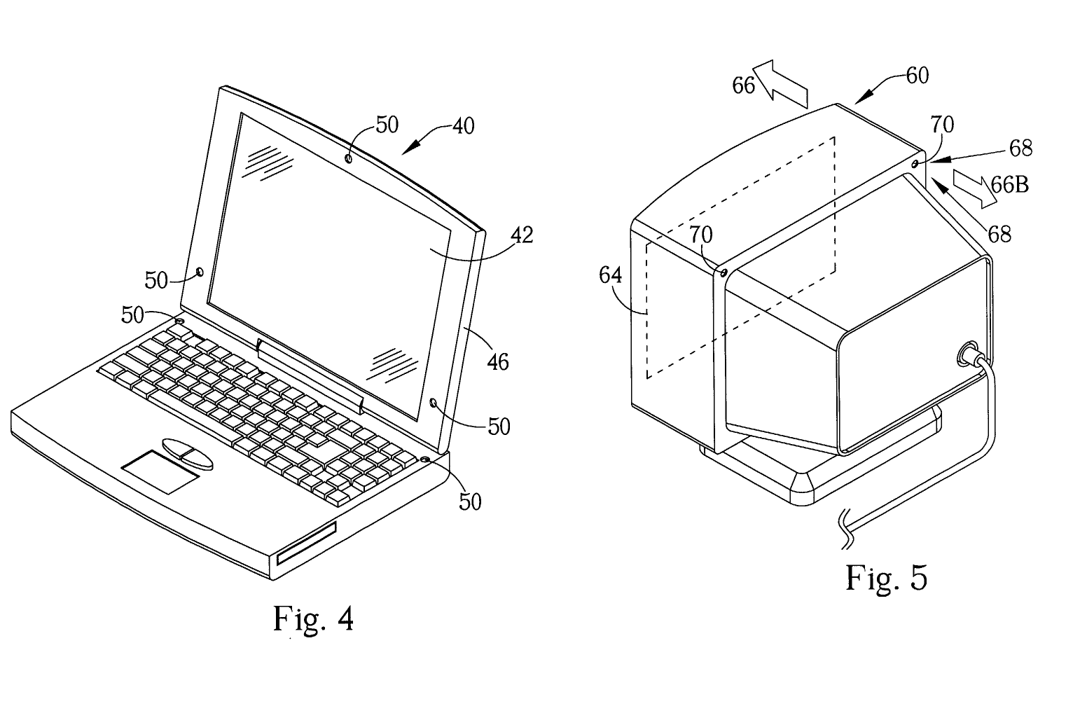

Please refer to FIG. 4. FIG. 4 is a perspective view of a portable computer system 40 according to the present invention. The portable computer system 40 comprises a display device 46 having a liquid crystal display (LCD) for displaying a color picture image. The display device 46 of the portable computer system 40 further comprises a plurality of sensors 50 for detecting light around the display device 46. The principles and operational methods for detecting signals from the sensors for adjusting the colors displayed on the screen is the same as those mentioned above. Please refer to FIG. 5. FIG. 5 is a perspective view of another display device 60 according to the present invention. As shown in FIG. 5, the present invention comprises sensors 70 disposed on the back of the display device 60. A screen 64 of the display device 60 is used to display a picture image for a user in front of the screen 64 along a direction of an arrowhead 66, and the sensors are installed on the back of the display device 60. A sensing surface of the sensor 70 faces towards the back of the screen 60 along a direction of an arrowhead 66B for detecting light incident on the sensing surface of the sensor 70 along a direction of an arrowhead 68 so as to adjust colors displayed on the screen 64. Furthermore, the preferred embodiment can adjust a brightness of the screen 64 according to a brightness of light detected by the sensor 70. For example, when the brightness of light detected by the sensor 70 is greater than a predetermined value, the brightness of the picture image displayed on the screen 64 can be correspondingly increased so as to reduce differences of the brightness between the screen 64 and surroundings.

In contrast to the prior art, the present invention display device utilizes a plurality of sensors to detect light around the display device and correspondingly adjust the color of the display device displayed through the screen so as to compensate color errors caused by the light.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A display device for a computer system comprising:
a screen for displaying a color picture image for a user in front of the screen, the color picture image formed by light emitted from at least two light sources of different colors;
at least one sensor for detecting light around the screen and generating a corresponding detecting signal;
a gray level adjusting device for adjusting brightness of light emitted by the light sources according to the detecting signal so as to reduce an impact of around the screen to the color picture image on the screen; and
a controller for controlling operations of the display device.

2. The display device of claim 1 wherein the sensor is disposed at a front side of the display device for sensing light emitted toward the screen.

3. The display device of claim 1 wherein the gray level adjusting device adjusts the brightness of the light emitted by the light sources so as to generate an expected picture image.

4. The display device of claim 1 wherein the controller is a display card of the computer system.

5. The display device of claim 1 wherein the computer system is a portable computer, and the display device is a liquid crystal display installed on the portable computer.

6. A display device for a computer system comprising:
a screen for displaying a picture image for a user in front of the screen;
at least one sensor for detecting light emitted to a sensing surface of the sensor and generating a corresponding detecting signal; and
a controller for adjusting the picture image displayed on the screen according to the detecting signal;
wherein the sensing surface of the sensor faces backwards so as to detect light emitted from the back of the display device.

7. The display device of claim 6 wherein the sensor is capable of detecting a brightness of light emitted to the sensing surface.

8. The display device of claim 6 wherein the sensor is capable of detecting a color of light emitted to the sensing surface.

9. The display device of claim 7 wherein the controller adjusts a brightness of the picture image according to the detecting signal.

10. The display device of claim 9 wherein when the brightness of light detected by the sensor is greater than a predetermined value, the controller will correspondingly increase the brightness of the picture image.

11. The display device of claim 8 wherein the controller adjusts a color of the picture image according to the detecting signal.

12. The display device of claim 11 wherein the controller adjusts the color of the picture image so as to generate an expected picture image.

13. The display device of claim 6 wherein the controller is a display card of the computer system.

14. The display device of claim 6 wherein the computer system is a portable computer, and the display device is a liquid crystal display installed on the portable computer.
